(19) United States
(12) Patent Application Publication
(10) Pub. No.: US 2005/0114175 A1
(43) Pub. Date: May 26, 2005

(54) Method and apparatus for managing ultrasound examination information

(76) Inventors: Paul Joseph O'Dea, Muskego, WI (US); Hemen Oza, Waukosha, WI (US)

Correspondence Address: Dean D. Small;Armstrong Teasdale LLP, Suite 2600, One Metropolitan Square, St. Louis, MO, 63102, US

(21) Appl. No.: 10/722,267

(22) Filed: Nov. 25, 2003

(51) Int. Cl. G06F 17/60

(52) U.S. Cl. 705/2

(57) ABSTRACT

A method and system for managing ultrasound examination information is provided. The method includes determining a completion of at least one ultrasound scan performed during an ultrasound examination and providing electronic notification of completion of the at least one ultrasound scan.

### BACKGROUND OF THE INVENTION

This invention relates generally to ultrasound systems and, more particularly, to methods and devices for managing ultrasound exam information from ultrasound systems.

Ultrasound systems typically include ultrasound scanning devices that allow for performing various different ultrasound scans (e.g., different examinations). These ultrasound scans may be predefined or controlled by a user operating the ultrasound system. When performing an examination of a patient, one or more specific ultrasound scans are usually scheduled prior to the examination. The ultrasound system thereby may be configured (e.g., select predetermined scan parameters) prior to the examination. Reports and other outputs, such as, for example, billing statements, are generated based upon the predetermined and scheduled examination scans. The reports and other outputs are generally combined per patient and any modifications (e.g., modifications based upon changes in scans during the examination procedure) must be manually communicated and thereafter processed, for example, for generating a billing statement.

For example, using known systems, hospitals bill patients and/or insurance companies for ultrasound procedures with the billing statements typically combined per patient. These billing statements cannot easily be separated for each procedure or examination, if at all. Further, and for example, the technician or other individual performing the procedure has to notify the billing department that the examination is complete and to process the billing for the patient. Additionally, if changes or additional scans are performed during the examination, such modifications also must be communicated to the billing department by the technician. Consequently, efficiency is reduced and costs increase. Errors also are more likely to occur as a result of this process.

### BRIEF DESCRIPTION OF THE INVENTION

In one exemplary embodiment, a method for managing ultrasound examination information is provided. The method includes determining a completion of at least one ultrasound scan performed during an ultrasound examination and providing electronic notification of completion of the at least one ultrasound scan.

In another exemplary embodiment, a user interface for an ultrasound system is provided. The user interface includes a control portion for controlling operation of an ultrasound system and a menu portion for receiving a user input indicating the completion of at least one ultrasound scan. An electronic notification is generated based upon the user input and used by a remote system for generating an output based upon ultrasound examination information.

### BRIEF DESCRIPTION OF THE DRAWINGS

FIG. 1 is a block diagram of an ultrasound system in accordance with one exemplary embodiment of the present invention.

FIG. 2 is a block diagram of an ultrasound system in accordance with another exemplary embodiment of the present invention.

FIG. 3 is a perspective view of an image of an object acquired by the systems of FIGS. 1 and 2 in accordance with an exemplary embodiment of the present invention.

FIGS. 4A and 4B are a block diagrams showing the ultrasound systems of FIGS. 1 and 2 in communication with a local data system.

FIG. 5 is a block diagram showing the ultrasound system of FIG. 1 in communication with an administrative system.

FIG. 6 is an exemplary embodiment of a user interface of an ultrasound system displaying a patient examination screen.

FIG. 7 is an exemplary embodiment of a user interface of an ultrasound system displaying an ultrasound image viewing screen.

FIG. 8 is an exemplary embodiment of a user interface of an ultrasound system displaying a main scan screen.

FIG. 9 is a flowchart illustrating an ultrasound examination information processing method in accordance with an exemplary embodiment of the present invention.

### DETAILED DESCRIPTION OF THE INVENTION

Exemplary embodiments of ultrasound systems and methods for managing ultrasound examination information are described in detail below. In particular, a detailed description of exemplary ultrasound systems will first be provided followed by a detailed description of various embodiments of methods and systems for managing ultrasound examination information. A technical effect of the various embodiments of the systems and methods described herein include at least one of facilitating managing of ultrasound examination information, communication of the ultrasound examination information and control of outputs relating to ultrasound scans.

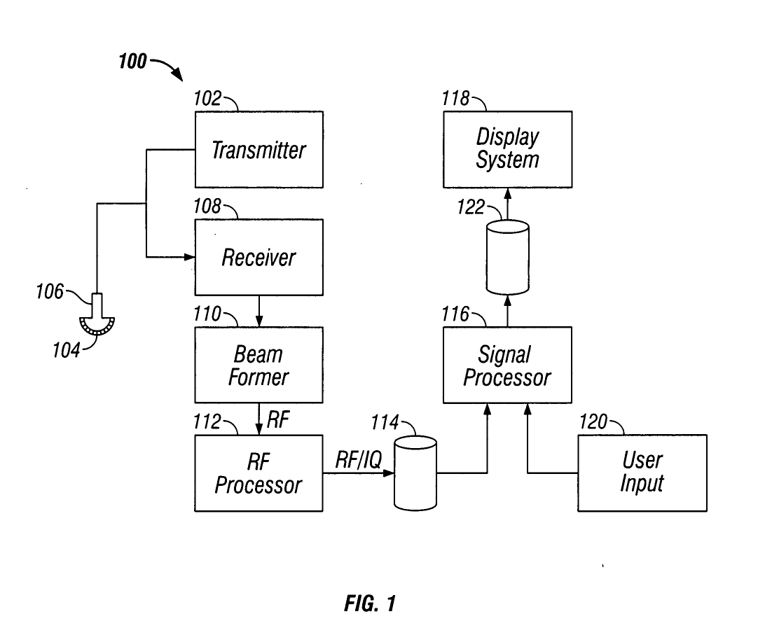

FIG. 1 illustrates a block diagram of an exemplary embodiment of an ultrasound system 100 that may be used, for example, to acquire and process ultrasonic images. The ultrasound system 100 includes a transmitter 102 that drives an array of elements 104 (e.g., piezoelectric crystals) within or formed as part of a transducer 106 to emit pulsed ultrasonic signals into a body or volume. A variety of geometries may be used and one or more transducers 106 may be provided as part of a probe (not shown). The pulsed ultrasonic signals are back-scattered from density interfaces and/or structures, for example, in a body, like blood cells or muscular tissue, to produce echoes that return to the elements 104. The echoes are received by a receiver 108 and provided to a beamformer 110. The beamformer performs beamforming on the received echoes and outputs an RF signal. The RF signal is then processed by an RF processor 112. The RF processor 112 may include a complex demodulator (not shown) that demodulates the RF signal to form IQ data pairs representative of the echo signals. The RF or IQ signal data then may be routed directly to an RF/IQ buffer 114 for storage (e.g., temporary storage).

The ultrasound system 100 also includes a signal processor 116 to process the acquired ultrasound information (i.e., RF signal data or IQ data pairs) and prepare frames of ultrasound information for display on a display system 118. The signal processor 116 is adapted to perform one or more processing operations according to a plurality of selectable ultrasound modalities on the acquired ultrasound information. Acquired ultrasound information may be processed in real-time during a scanning session as the echo signals are received. Additionally or alternatively, the ultrasound information may be stored temporarily in the RF/IQ buffer 114 during a scanning session and processed in less than real-time in a live or off-line operation.

The ultrasound system 100 may continuously acquire ultrasound information at a frame rate that exceeds fifty frames per second, which is the approximate perception rate of the human eye. The acquired ultrasound information is displayed on the display system 118 at a slower frame-rate. An image buffer 122 may be included for storing processed frames of acquired ultrasound information that are not scheduled to be displayed immediately. In an exemplary embodiment, the image buffer 122 is of sufficient capacity to store at least several seconds of frames of ultrasound information. The frames of ultrasound information may be stored in a manner to facilitate retrieval thereof according to their order or time of acquisition. The image buffer 122 may comprise any known data storage medium.

A user input device 120 as described in more detail below may be used to control operation of the ultrasound system 100. The user input device 120 may be any suitable device and/or user interface for receiving user inputs to control, for example, the output of ultrasound examination information useful in a patient billing process.

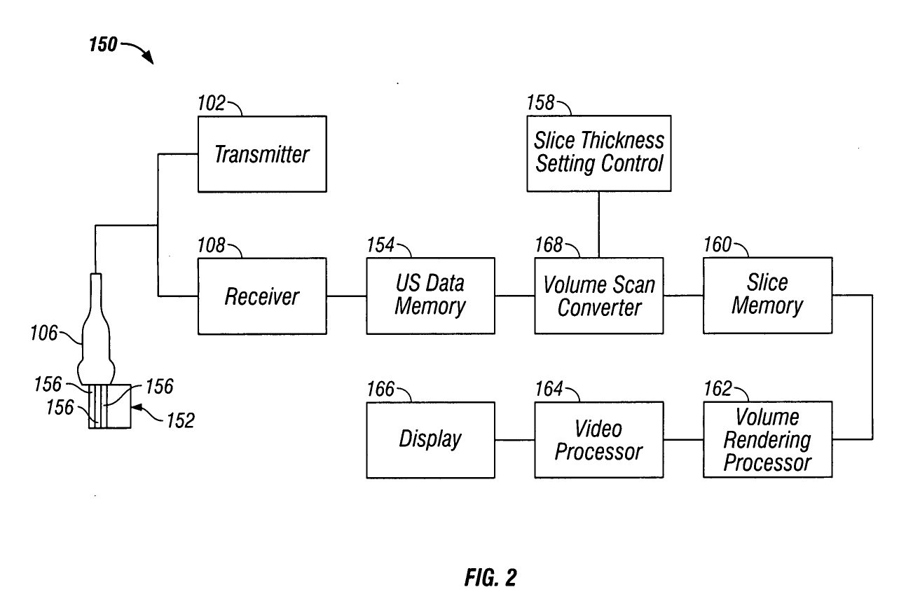

FIG. 2 illustrates a block diagram of another exemplary embodiment of an ultrasound system 150 that may be used, for example, to acquire and process ultrasonic images. The ultrasound system 150 includes the transducer 106 in communication with the transmitter 102 and receiver 108. The transducer 106 transmits ultrasonic pulses and receives echoes from structures inside a scanned ultrasound volume 152. A memory 154 stores ultrasound data from the receiver 108 derived from the scanned ultrasound volume 152. The scanned ultrasound volume 152 may be obtained by various techniques, including, for example, 3D scanning, real-time 3D imaging, volume scanning, scanning with transducers having positioning sensors, freehand scanning using a Voxel correlation technique, 2D scanning or scanning with a matrix of array transducers, among others.

The transducer 106 is moved, such as along a linear or arcuate path, while scanning a region of interest (ROI). At each linear or arcuate position, the transducer 106 obtains a plurality of scan planes 156. The scan planes 156 are collected for a thickness, such as from a group or set of adjacent scan planes 156. The scan planes 156 are stored in the memory 154, and then provided to a volume scan converter 168. In some exemplary embodiments, the transducer 106 may obtain lines instead of the scan planes 156, with the memory 154 storing lines obtained by the transducer 106 rather than the scan planes 156. The volume scan converter 168 receives a slice thickness setting from a slice thickness setting control 158, which identifies the thickness of a slice to be created from the scan planes 156. The volume scan converter 168 creates a data slice from multiple adjacent scan planes 156. The number of adjacent scan planes 156 that are obtained to form each data slice is dependent upon the thickness selected by the slice thickness setting control 158. The data slice is stored in a slice memory 160 and accessed by a volume rendering processor 162. The volume rendering processor 162 performs volume rendering upon the data slice. The output of the volume rendering processor 162 is provided to a video processor 164 that processes the volume rendered data slice for display on a display 166.

It should be noted that the position of each echo signal sample (Voxel) is defined in terms of geometrical accuracy (i.e., the distance from one Voxel to the next) and ultrasonic response (and derived values from the ultrasonic response). Suitable ultrasonic responses include gray scale values, color flow values, and angio or power Doppler information. It also should be noted that the ultrasound system 150 may include a user input or user interface for controlling the operation of the ultrasound system 150.

It should be noted that the ultrasound systems 100 and 150 may include additional or different components. For example, the ultrasound system 150 may include a user interface or user input 120 (shown in FIG. 1) to control the operation of the ultrasound system 150, including, to control the input of patient data, scan parameters, a change of scan mode, and the like.

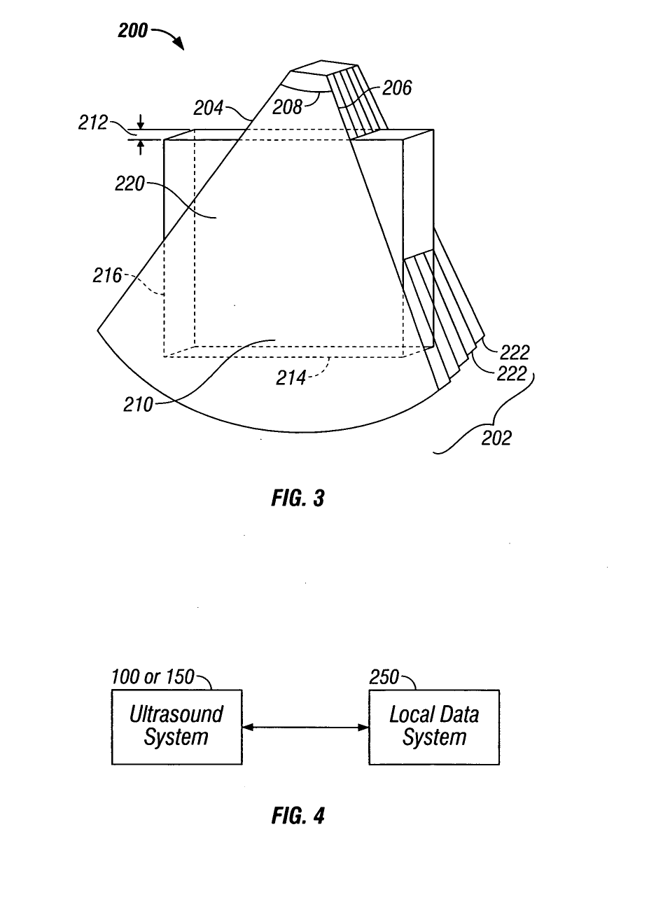

FIG. 3 illustrates an exemplary image of an object 200 acquired by the ultrasound systems 100 and 150. The object 200 includes a volume 202 defined by a plurality of sector shaped cross-sections with radial borders 204 and 206 diverging from one another at an angle 208. The transducer 106 (shown in FIGS. 1 and 2) electronically focuses and directs ultrasound firings longitudinally to scan along adjacent scan lines in each scan plane 156 (shown in FIG. 2) and electronically or mechanically focuses and directs ultrasound firings laterally to scan adjacent scan planes 156. The scan planes 156 obtained by the transducer 106, and as illustrated in FIG. 1, are stored in the memory 154 and are scan converted from spherical to Cartesian coordinates by the volume scan converter 168. A volume comprising multiple scan planes 156 is output from the volume scan converter 168 and stored in the slice memory 160 as a rendering region 210. The rendering region 210 in the slice memory 160 is formed from multiple adjacent scan planes 156.

The rendering region 210 may be defined in size by an operator using a user interface or input to have a slice thickness 212, width 214 and height 216. The volume scan converter 168 (shown in FIG. 2) may be controlled by the slice thickness setting control 158 (shown in FIG. 2) to adjust the thickness parameter of the slice to form a rendering region 210 of the desired thickness. The rendering region 210 defines the portion of the scanned ultrasound volume 152 that is volume rendered. The volume rendering processor 162 accesses the slice memory 160 and renders along the slice thickness 212 of the rendering region 210.

Referring now to FIGS. 1 and 2, during operation, a slice having a pre-defined, substantially constant thickness (also referred to as the rendering region 210) is determined by the slice thickness setting control 158 and is processed in the volume scan converter 168. The echo data representing the rendering region 210 (shown in FIG. 3) may be stored in the slice memory 160. Predefined thicknesses between about 2 mm and about 20 mm are typical, however, thicknesses less than about 2 mm or greater than about 20 mm may also be suitable depending on the application and the size of the area to be scanned. The slice thickness setting control 158 may include a control member, such as a rotatable knob with discrete or continuous thickness settings.

The volume rendering processor 162 projects the rendering region 210 onto an image portion 220 of an image plane(s) 222 (shown in FIG. 3). Following processing in the volume rendering processor 162, pixel data in the image portion 220 may be processed by the video processor 164 and then displayed on the display 166. The rendering region 210 may be located at any position and oriented at any direction within the volume 202. In some situations, depending on the size of the region being scanned, it may be advantageous for the rendering region 210 to be only a small portion of the volume 202.

The ultrasound systems 100 and 150 may be provided in communication with a local data system 250 as shown in FIGS. 4A and 4B. For example, in an exemplary embodiment the ultrasound systems 100 and 150 may have the local data system 250 configured as a local data archive having stored therein information relating to ultrasound examinations. This information may be entered, for example, using the user input 120 or other user interface, and may include patient information (e.g., name, address, scanning history, etc.), exam information regarding ultrasound scans to be performed, appointment information and work lists relating to scheduled ultrasound scans for specific patients. As another example, and in another exemplary embodiment, the ultrasound systems 100 and 150 may be connected with the local data system 250 and configured as a local server having stored therein information relating to ultrasound examinations. It should be noted that the information within the local data system 250 may be stored, for example, within a patient database.

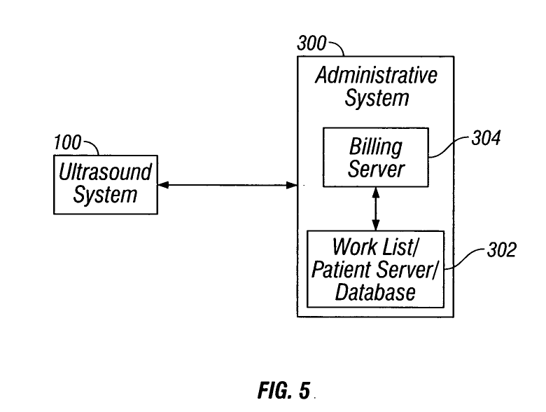

The ultrasound system 100 or 150 may be provided in communication with an administrative system 300 as shown in FIG. 5. In an exemplary embodiment, the administrative system 300 is located remote from the ultrasound system 100 or 150 (e.g., in another area of a hospital). In this exemplary embodiment, the information relating to the ultrasound examinations (e.g., patient information and examination scheduling information) may be entered, for example, within a hospital at a location separate from the ultrasound systems 100 and 150, such as in a data entry room or at a reception area. This information then may be stored, for example, within a server/database, such as a work list/patient server/database 302 within the administrative system 300 at the hospital. The information then may be accessed (e.g., downloaded) by the ultrasound systems 100 and 150. For example, upon a request from a user (e.g., sonographer) at a scanner provided as part of the ultrasound system 100 or 150, requested information from a work list for a particular exam is communicated to the ultrasound system 100 or 150. This information may include, for example, a patient's name, the examination scheduled to be performed, the specifics regarding the procedures to be performed, etc. This information typically relates to, for example, a previously ordered ultrasound examination, which may include one or more ultrasound procedures or scans. The administrative system 300 also may include other servers providing specific functionality or operations, such as, for example, a billing server 304 providing billing operations (e.g., generating billing statements).

Various embodiments of the present invention allow for bi-directional communication between the ultrasound scanners 100 and 150 and the administrative system 300 to obtain information relating to a particular examination, update information relating to the examination, generate notifications relating to ultrasound examinations and dynamically generate outputs based upon certain events.

Referring now to a user interface or input, such as, for example, the user input device 120 (shown in FIG. 1), various embodiments of the invention may be implemented for managing ultrasound information relating to the ultrasound systems 100 and 150. Such various embodiments may include control functionality, such as a set of user controls for controlling the ultrasound systems 100 and 150. The set of user controls may be provided, for example, as part of a touch screen or panel, or as manual inputs, including, for example, user operable switches, buttons, and the like.

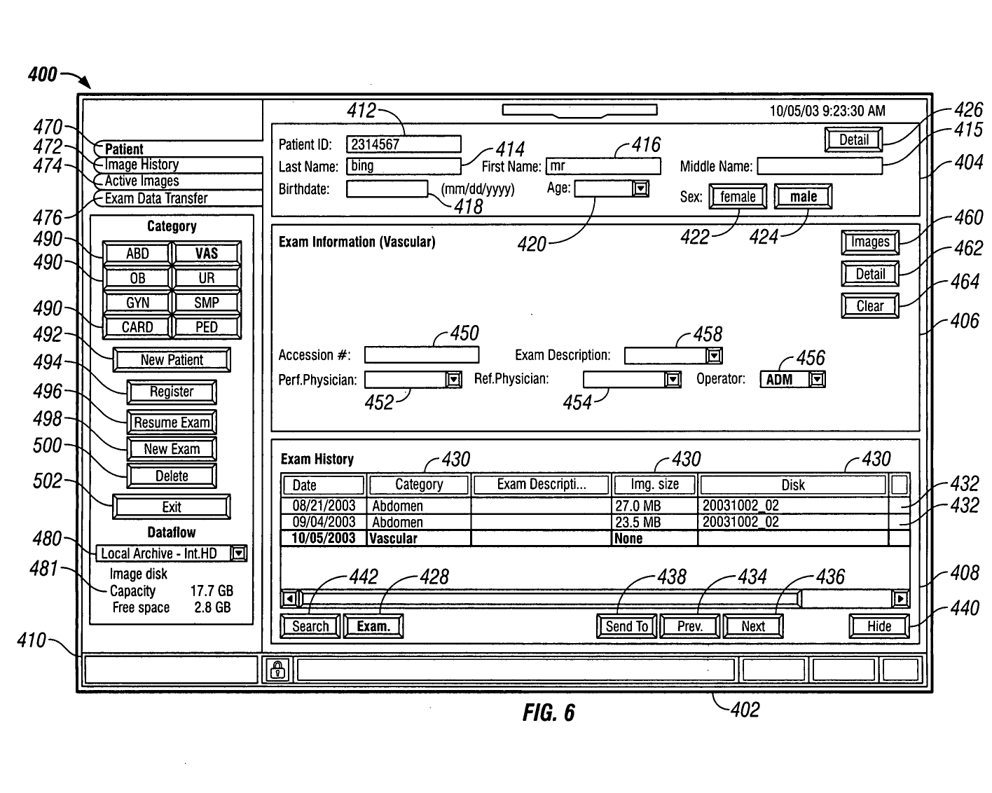

In an exemplary embodiment as shown in FIG. 6, a user input device 120 may include a user interface, such as, for example, a panel or screen that is operable and selectable by touching the screen or using a keyboard or other user input to select the desired operation or command for controlling the ultrasound systems 100 and 150. Specifically, a user interface 400 for managing examination data is shown in FIG. 6. The user interface 400 is shown displaying a patient examination screen 402 that may displayed on a screen provided as part of, for example, the user input 120 (shown in FIG. 1) or on the display 166 (shown in FIG. 2). The patient examination screen 402 allows a user to search, access, select and/or update information regarding specific examinations and procedures relating to an ultrasound scan. The patient examination screen 402 includes a patient information portion 404, an exam information portion 406, an exam history portion 408 and a scan control portion 410. The patient information portion 404 allows a user to enter and/or search for information relating to a specific patient. The exam information portion 406 allows a user to enter and/or search for information relating to a specific examination for a particular patient. The exam history portion 408 displays exam history information for a particular patient and allows a user to search for exam history information. The scan control portion 410 allows a user to select and/or control a scan relating to a particular selected patient.

In particular, the patient information portion 404 includes a Patient ID field 412, allowing for searching based upon an identification number (e.g., hospital ID number) for example, for a patient, a Last Name field 414, Middle Name field 415 and a First Name field 416 allowing for searching based upon a name (e.g., patient's name), and a Birthdate field 418 and an Age field 420 allowing for searching based upon a birth date and age. Further, Sex selection members 422 and 424 (e.g., selectable buttons) allow for searching based upon sex (e.g., patient's sex). A user may also obtain additional information relating to a particular patient by selecting the Detail selection member 426.

Upon entering one or more desired search terms, examination information for one or more patients satisfying the search criteria is displayed on the patient examination screen 402. If information relating to more than one patient is available, in one exemplary embodiment, a user selects a single patient to view information relating to that patient. Specifically, exam history information relating to the selected patient is displayed in the exam history portion 408 when an Exam selection member 428 is selected. The information includes ultrasound examination information stored, for example, in a local scanner relating to the patient. Additional information relating to a patient also may be downloaded, for example, form the administrative system 300. The information displayed may be configured as columns 430 and may include, for example, the dates of previous examinations, the category of the examination (e.g., general type of examination), a description of the examination(s), the size of the ultrasound images corresponding to the examinations and the location (e.g., disk location) of the images. In an exemplary embodiment, a separate row 432 is displayed for each examination. A user may select a specific a row 432 corresponding to a particular examination in order to access or update information relating to the selected examination. A separate screen (not shown) may be provided to view or update the selected examination information or the information may be displayed on the patient examination screen 402 (e.g., as a separate pop-up window). A user may scroll through the information in the columns 430 or scroll through, for example, images, using a Prev. selection member 434 and a Next selection member 436, which allow for selection of the previous or next examination or image, respectively.

A user may also export information (e.g., transmit to another archive or system) relating to one or more examinations from the ultrasound systems 100 or 150 by selecting a Send To selection member 438. This may, for example, cause the user interface 400 to display a send to screen, which may be provided, for example, as a pop-up screen that allows the user to, for example, send images to another device or media. The exam history portion 408 may be hidden from display by selecting a Hide selection member 440. The other portions displayed on the patient examination screen 402 may then, for example, expand to fill more of the user interface 400. A user may also search for exam history information by selecting a Search selection member 442, which may cause the user interface 400 to display a search screen.

A user may update information relating to an examination or enter information relating to a new examination using the exam information portion 406. This may include updating information relating to an examination presently being performed, scheduled to be performed and/or to be performed (and not scheduled). The exam information portion 406 includes an Accession# field 450 for entering an accession number that is used with the a patient identification number entered in the Patient ID field 412 to specify a patient examination or study based upon a DICOM standard, a Perf. Physician field 452 for entering performing physician information, a Ref. Physician field 454 for entering referring physician information, an Operator field 456 for entering operator information (e.g., initials of sonographer performing examination), and an Exam Description field 458 for entering information, such as a description of the examination performed. In an exemplary embodiment, the information entered in the exam information portion 406 corresponds to an examination selected in the exam history portion 408. It should be noted that this may be a scheduled examination already displayed in the exam history portion 408 as downloaded from the administrative system 300, a scheduled examination not downloaded from the administrative system 300 or an unscheduled examination entered by the user.

The exam information portion 406 also includes an Image selection member 460 that allows a user to access images relating to the current and/or a past examination, for example, to view thumbnails of images on the screen. A Detail selection member 462 allows a user to access and enter more details relating to the examination, such as, for example, by displaying fields in the patient information portion 404 for entering text information, including, for example the following fields: indications, comments, admission#, performing physician or preferred physician telephone number, referring physician telephone number and operator telephone number. A Clear selection member 464 allows a user to clear all the fields in the exam information portion 406 when selected. Although buttons and/or pull-down menus/lists are shown in the exemplary embodiments, other selection means may be used, such as, for example, check boxes.

The scan control portion 410 includes general control options relating to the ultrasound systems 100 and 150 (shown in FIGS. 1 and 2) and specific control options relating to the examination information displayed. For example, a patient selection member 470 allows a user to select the patient examination screen 402, an image selection member 472 allows a user to access a screen for viewing ultrasound image history information, an active images selection member 474 allows a user to access a screen for viewing active ultrasound images (e.g., images relating to a current examination) and an exam data transfer selection member 476 allows a user to access a screen for transferring data (e.g., ultrasound images) relating to an examination. The scan control portion 410 also includes a Dataflow field 480 for selecting the location to store scanned images or access stored images (e.g., a local hard disk archive) and a storage information portion 481 displaying information relating to the current storage member being used to store images, such as, for example, the image disk capacity and free space for a selected storage location. In one exemplary embodiment the storage information portion 481 displays information relating to local data system 250 (e.g., local hard drive, local MOD, local CD).

The scan control portion 410 includes a plurality of category selection members 490 for selecting a particular scan (e.g., abdominal, vascular, etc.) for the type of examination scan being performed and/or the type of transducer to use (e.g., select an examination category). A New Patient selection member 492 is provided for accessing a screen that allows a user to enter information relating to a new patient (e.g., address, date of birth, etc.) directly at the scanner, and in one exemplary embodiment, ends the current patient session displayed. A Register selection member 494 activates a session, for example, an examination using the current patient information (e.g., current patient information becomes current active patient information), which allows and examination to be performed and information (e.g., images) relating to the current patient to be stored.

A Resume Exam selection member 496 allows a user to resume an examination that has been ended. For example, if an examination is ended, and during the same day a doctor or another sonographer decided that they wanted to obtain more data (e.g., images) relating to the patient (e.g., based upon viewing the existing images), the examination stored for that day may be resumed, and images may be acquired and stored. Additionally, and for example, another examination session may be created. A New Exam selection member 498 allows a user to select a new examination and ends the current examination (e.g., allows user to select another examination category using the category selection members 490). Further, and for example, the current ultrasound examination information (e.g., images) will become part of the exam history displayed in the exam history portion 408 and a new current exam highlighted in the exam history list. A user may then enter more information regarding the previous examination before proceeding to the next examination. A Delete selection member 500 allows a user to delete information relating to an examination, for example to delete information relating to a current examination or one listed in the exam history portion 408. In one exemplary embodiment, this deletes all ultrasound examination information (e.g., images stored in the local data system 250 as part of a scanner) relating to the selected examination. It should be noted that ultrasound examination information relating to particular selected patient also may be deleted. An Exit selection member 502 allows a user to exit the patient examination screen 402 and the user interface 400 displays a main screen having general control options as described herein.

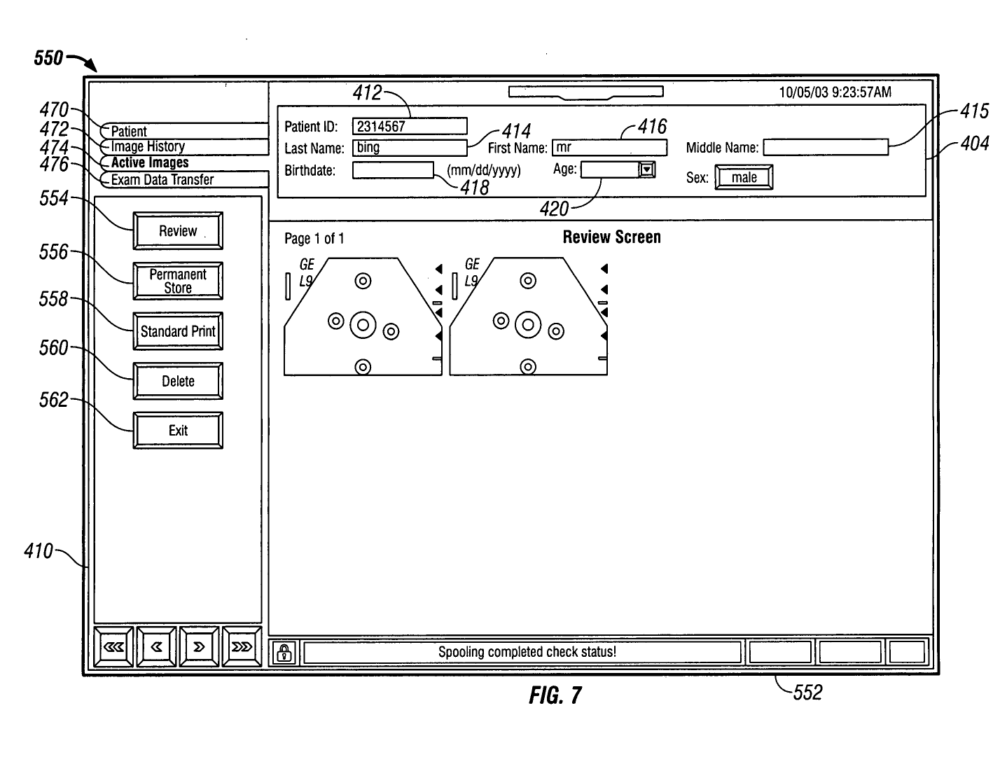

Another user interface 550 for managing examination data is shown in FIG. 7. The user interface 550 is shown displaying an ultrasound image viewing screen 552 that may displayed on a screen provided as part of, for example, the user input 120 (shown in FIG. 1) or on the display 166 (shown in FIG. 2). The ultrasound image viewing screen 552 allows a user to select and control the viewing of ultrasound images relating to an ultrasound scan, which may be displayed after completing an exam and exiting the user interface 400 (shown in FIG. 6) using the Exit selection member 502. The ultrasound image viewing screen 552 includes the patient information portion 404 and a scan control portion 410, which may include some or all of the fields that are provided in the user interface 400 or may include selection members corresponding to functionality available on the currently displayed screen. For example, and in an exemplary embodiment, the control portion 410 includes a Review selection member 554 for reviewing scanned images, a Permanent Store selection member 556 for permanently storing images (e.g., store image to a local image disk), a Print selection member 558 for printing one or more images (e.g., printing images to an attached or networked printer), a Delete selection member 560 for deleting one or more images and an Exit selection member 562 for exiting the a ultrasound image viewing screen 552.

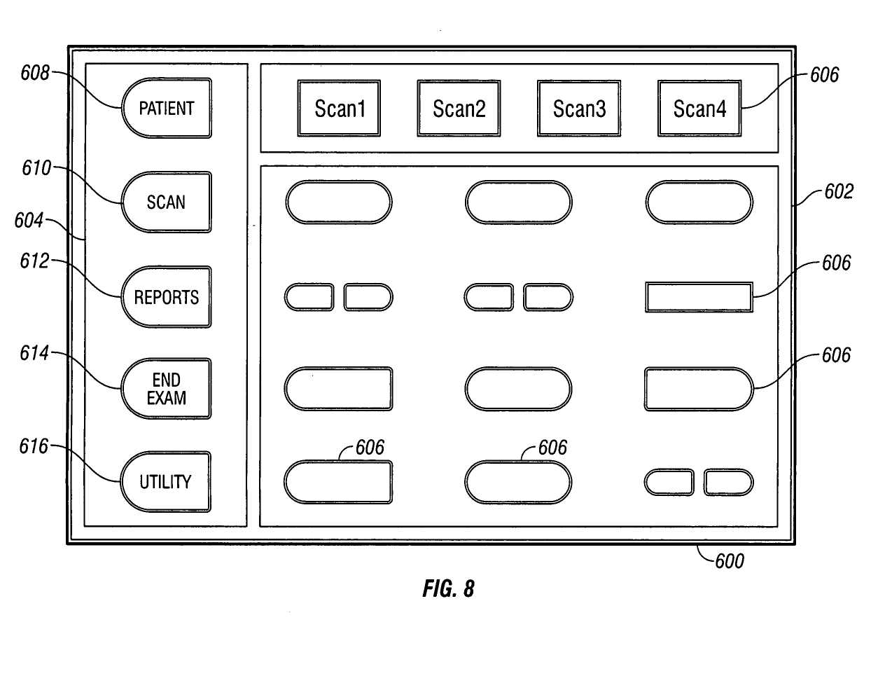

It should be noted that the screen displayed after a user selects the Exit selection member 560 or 502 (shown in FIG. 6) may be, for example, a predetermined screen based upon user preferences, system requirements or a current application. In an exemplary embodiment, a main scan screen 600 as shown in FIG. 8 is displayed and includes a control portion 602 for controlling various operations of the ultrasound systems 100 and 150 (e.g., compounding, enhancement, coloring, etc.) and a menu portion 604 for selecting an operation screen to be displayed and/or a function to be performed. The selection members and/or other selectable elements may be configured as icons or other suitable members allowing for selection by a user (e.g., using a mouse or touching a touch screen). Selection members 606 in the control portion 602 may be configured, for example, to allow control of operation of the ultrasound systems 100 and 150 (e.g., control operating parameters) based upon a selected scan mode of operation. The selection members in the menu potion 604 may be configured in an exemplary embodiment, for example, as icons to select general operations such as to enter patient information (Patient icon 608), start a scan (Scan icon 610), create or generate a report (Reports icon 612), end a scan or exam (End Exam icon 614) and/or configure the ultrasound systems 100 and 150 (Utility icon 616).

It should be noted that the selectable elements described herein are not limited to, for example, the selection members, fields and icons, but may include any suitable selectable element capable of selection by a user.

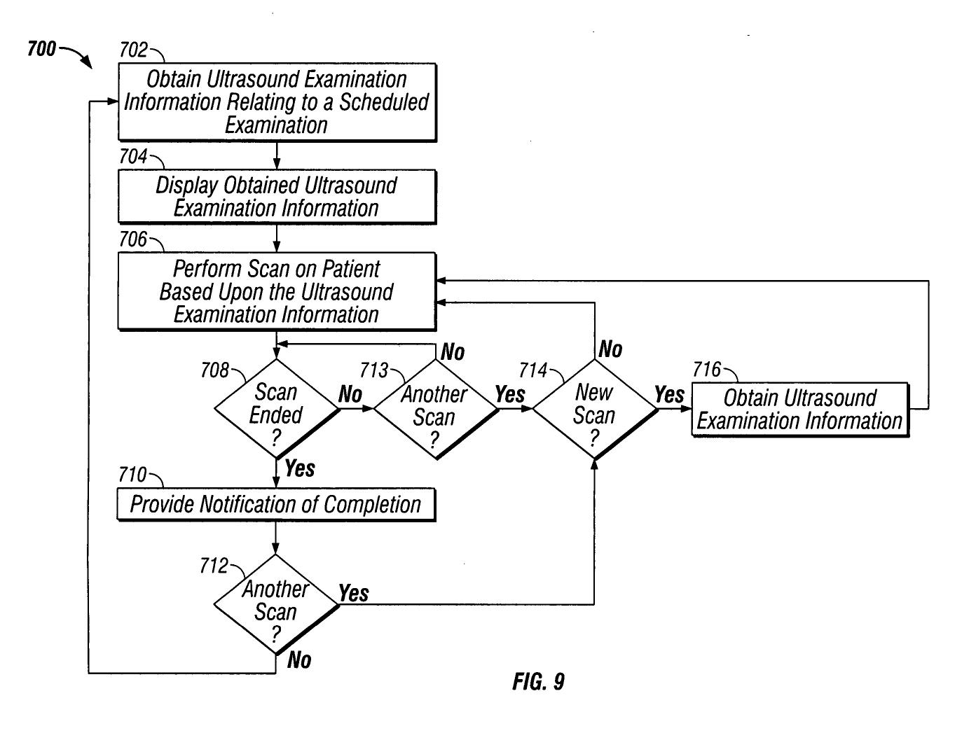

In operation, a user may search for and select a patient for which an exam is to be performed and update or change the examination information, with various embodiments of the present invention providing notification of such updating or changing, as well as the completion of the exam, for example, to allow for generating of billing statements. Specifically, an exemplary embodiment of an ultrasound examination information processing method 700 for managing ultrasound examination data obtained using the ultrasound systems 100 and 150 and various interfaces is shown in FIG. 9. As shown therein, information relating to a scheduled examination is obtained at 702, for example from the local data system 250 (shown in FIG. 4) and/or the administrative system 300 (shown in FIG. 5). This may include obtaining (e.g., downloading) general information relating to the patient (e.g., name, age, sex, etc.), information relating to the type(s) of scans scheduled to be performed, the date and time of the scheduled scan(s), etc. In an exemplary embodiment, this information in stored within a patient database in the administrative system 300, which may be a local network at a hospital, such as the work list/patient server/database 302.

In an exemplary embodiment, information relating to the patient and examination are stored in a work list that sets forth the specifics of the examination to be performed. In an exemplary embodiment, a separate work list server is provided as part of the local data system 250 or administrative system 300 (e.g., as part of the work list/patient server/database 302). The patient and examination information, including the work list may be downloaded, for example, to the ultrasound system 100 or 150 at a predetermined time period before the scheduled examination or upon request, for example, by a sonographer using the user interfaces (e.g., performing a search). The communication of information between the ultrasound systems 100 and 150 and the local data system 250 or administrative system 300 may be provided in any suitable manner as needed or desired. For example, a Picture Archiving and Communication System (PACS) standard and/or Digital Imaging and Communications in Medicine (DICOM) standard may be used to provide communication between the ultrasound systems 100 and 150 and the local data system 250 or administrative system 300.

The obtained ultrasound examination information is provided to a user at the ultrasound system 100 or 150 at 704. This may include, for example, displaying patient and scan information (e.g., images) with the user interfaces described in more detail herein. The user is then able to determine the scans to be performed and any additional information that may be needed. One or more scans are then performed at 706 based upon the displayed ultrasound examination information using, for example, the ultrasound system 100 or 150. For example, a sonographer may control operation of the ultrasound system 100 or 150, or other ultrasound system using the interfaces or as is known. A determination is then made at 708 as to whether the one or more scans are completed or ended. In an exemplary embodiment, a determination is made as to whether the End Exam icon 614 has been selected, indicating that the current scan is complete and/or has ended. If the scan is completed or ended, a notification (e.g., automatic and/or dynamic electronic notification) is provided accordingly at 710. For example, a completion signal may be transmitted from the ultrasound system 100 or 150 to the administrative system 300 indicating the completion of the scan. In an alternative embodiment, completion of the scan may be determined based upon the expiration of a predetermined time period for a scan or upon receiving a signal from the ultrasound system 100 or 150 that the scan is complete (e.g., transducer is powered off). Thereafter, a completion signal is communicated (e.g., transmitted) from the ultrasound system 100 or 150 to the administrative system 300. This may include, for example, sending a completion message signal generated at the ultrasound system 100 or 150 to the administrative system 300 via a network or other communication link. In another exemplary embodiment, a determination may be made as to whether the New Exam selection member 498 has been selected, indicating that the current scan is complete and/or has ended.

The administrative system 300 then may, for example, upon receiving the completion signal, automatically generate a billing statement relating to the completed scan in any know manner, including, for example, automatically generating appropriate billing codes, with the information regarding the scan stored in the patient database (e.g., work list/patient server/database 302) accessed for generating the billing statement. It should be noted that the completion signal may be used to generate other outputs, for example, reports for the hospital, patient scheduling lists, technician scheduling lists, technician time sheets, etc.

After providing the notification at 710, a determination is made at 712 as to whether another scan is to be performed. This may be a scheduled scan or an unscheduled scan. If no further scans are to be performed for the patient during the examination, ultrasound examination information relating to the next examination may be obtained at 702. If another scan is to be performed as determined at 712 or if at 708 a determination is made that the scan has not ended and at 713 a determination is made that another scan is to be performed, a determination is made at 714 as to whether the next scan is a new scan (e.g., unscheduled scan). If the scan is not a new scan, for example, if the scan is a scan scheduled on the work list, then the scan is performed at 706 based upon the previously obtained ultrasound examination information when the ultrasound system 100 or 150 is available (e.g., previous exam ended). If a determination is made at 714 that the scan is a new scan, then at 716 ultrasound examination information is obtained regarding the new scan. This may include, for example, obtaining information entered locally at the ultrasound system 100 or 150 by a user (e.g., user determines an additional scan is needed or desired). This information may be entered, for example, using the interfaces described herein. After the ultrasound examination information regarding the new scan is entered (e.g., parameters or type of new scan), in an exemplary embodiment, the information is transmitted to the local data system 250 and/or administrative system 300 and stored, for example, in the work list/patient server/database 302. Thereafter, the scan may be performed at 706.

Thus, in operation, and for example, notification of the completion of one or more scans may be provided for use in generating outputs, such as billing statements. Separate outputs thereby automatically may be generated based upon different criteria, such as, for example, the different types of scans, the doctors ordering the scans, the insurance company to be billed for the scan, etc., which may be based, for example, on specific codes (e.g., billing codes). For example, the billing server 304 (shown in FIG. 5) may automatically generate billing statements based upon the automatic notification and information stored with the work list/patient server/database 302. Thus, once a scan and/or exam is complete, notification may be provided to the work list/patient server/database 302, which notifies the billing server 304 to generate a report or billing statement. Separate notifications may be provided at the completion of each scan or exam, whether scheduled or unscheduled, and used to generate outputs based upon specific criteria.

Thus, various exemplary embodiments provide for managing ultrasound examination information that allows flexibility in generating outputs. Modifications, changes and additions to the ultrasound examination information during an ultrasound examination also may be managed.

While the invention has been described in terms of various specific embodiments, those skilled in the art will recognize that the invention can be practiced with modification within the spirit and scope of the claims.

1. A method for managing ultrasound examination information, the method comprising:
determining a completion of at least one ultrasound scan performed during an ultrasound examination; and
providing electronic notification of completion of the at least one ultrasound scan.

2. A method in accordance with claim 1 further comprising generating an output based upon the electronic notification.

3. A method in accordance with claim 2 wherein the output comprises at least one billing statement.

4. A method in accordance with claim 2 wherein the generating is provided automatically upon the completion of the at least one scan.

5. A method in accordance with claim 1 wherein at least one of the ultrasound scans comprises an unscheduled scan.

6. A method in accordance with claim 1 wherein the electronic notification is provided automatically upon completion of a scan.

7. A method in accordance with claim 1 wherein the electronic notification is provided based upon a user input.

8. A method in accordance with claim 1 further comprising associating completed ultrasound scans with patient information.

9. A method in accordance with claim 1 wherein the generating comprises using at least one predetermined criteria to configure the output.

10. A method in accordance with claim 1 wherein at least one of the ultrasound scans is scheduled and further comprising obtaining ultrasound examination information relating to the at least one scheduled ultrasound scan.

11. A method in accordance with claim 10 further comprising searching a patient database for the ultrasound examination information.

12. A method in accordance with claim 1 wherein at least one of the ultrasound scans is unscheduled and further comprising updating ultrasound examination information relating to the at least one unscheduled ultrasound scan.

13. A method in accordance with claim 1 wherein the determining comprises receiving a user input indicating the completion of at least one scan.

14. A method for managing ultrasound examination information, the method comprising:
searching a database for ultrasound examination information based upon a user input, the ultrasound examination information relating to one or more ultrasound scans to be performed during an ultrasound examination; and
generating an output based upon an electronic notification that at least one of the one or more ultrasound scans is complete, the output corresponding to the ultrasound examination information and provided remote from an ultrasound system used to perform the ultrasound examination.

15. A method in accordance with claim 14 wherein the output comprises at least one billing statement.

16. A method in accordance with claim 14 wherein a separate output is generated in connection with each electronic notification.

17. A method in accordance with claim 14 further comprising configuring the output based upon predefined criteria.

18. A method in accordance with claim 14 wherein the electronic notification is generated based upon a user input.

19. A method in accordance with claim 14 wherein the electronic notification is automatically generated upon completion of an ultrasound scan.

20. A method in accordance with claim 14 wherein the electronic notification is dynamically generated.

21. A user interface for an ultrasound system comprising:
a control portion for controlling operation of an ultrasound system; and
a menu portion for receiving a user input indicating the completion of at least one ultrasound scan, an electronic notification generated based upon the user input and used by a remote system for generating an output based upon ultrasound examination information.

22. A user interface in accordance with claim 21 wherein the menu portion is configured to allow for selection of a plurality of user screens, at least one of the screens providing fields for searching the ultrasound examination information.
